(19) United States
(12) Patent Application Publication
(10) Pub. No.: US 2008/0160833 A1
(43) Pub. Date: Jul. 3, 2008

(54) WIRE-LINE CONNECTION SYSTEM

(76) Inventor: Ken Shipalesky, Spruce Grove (CA)

Correspondence Address: BOND, SCHOENECK & KING, PLLC, ONE LINCOLN CENTER, SYRACUSE, NY, 13202-1355, US

(21) Appl. No.: 11/966,006

(22) Filed: Dec. 28, 2007

(30) Foreign Application Priority Data
Jan. 3, 2007 (CA) 2572755
Sep. 28, 2007 (CA) 2604816

(51) Int. Cl. H01R 13/40

(52) U.S. Cl. 439/625

(57) ABSTRACT

A wire-line section and connection system for carrying electrical power to a down-hole tool in a well is provided. Each section includes a tubular sheath forming a passageway that encloses a conductor having a first connector at one end and a complementary second connector at the other that enables wire-line sections to be coupled together. A number of wire-line sections can be connected together to form a wire-line connection system that connects to a device connector attached to the down-hole tool. The upper end of the system includes an entry sub-assembly to connect to a source of electric power for the down-hole tool.

### PRIORITY CLAIM

This application claims the priority of Canadian Patent Application no. 2,572,755 for “Wire-Line Connection System” filed on Jan. 3, 2007, and further claims the priority of Canadian Patent Application no. 2,604,816 for “Wire-Line Connection System” filed on Sep. 28, 2007. The entireties of both priority applications are hereby incorporated by reference.

### FIELD OF THE INVENTION

The present invention is related to the field of wire-line connection systems used to provide electrical power to down-hole tools in wells.

### BACKGROUND

It is known in the art to use a wire-line connection system, comprising a series of modular component sections, to convey electric current to or from down-hole devices, such as, but not limited to, survey, navigation, exploration, sensor and drilling devices but many of these systems are complex and expensive to implement.

It is, therefore, desirable to provide a wire-line connection system that can form a releasable, fluid-tight and interlocking connection between wire-line sections that are simple and inexpensive to manufacture.

### SUMMARY

A wire-line section for transmitting electricity to a down-hole device is provided. The wire-line section can comprise: a tubular sheath having first and second ends and forming a passageway therebetween; a conductor disposed within said passageway extending between said first and second ends; a first connector operatively attached to said conductor at said first end, said first connector operatively attached to said first end of said tubular sheath; a second connector operatively attached to said conductor at said second end, said first and second connectors configured to releasably connect with one another; and coupling means for releasably coupling said first connector with the second end of a second wire-line section whereupon releasably coupling said wire-line section to said second wire-line section, said first connector is releasably connected with the second connector of said second wire-line section.

In one embodiment, the tubular sheath can have open first and second ends and can be made of suitable electrically insulating (non-conducting) material. In another embodiment, the tubular sheath can be made of polyvinylchloride. In a representative embodiment, the tubular sheath can be a polyvinylchloride pipe having a ¼-inch inside diameter.

The conductor can be coaxially mounted within the passageway of the tubular sheath such that the tubular sheath protects and insulates the conductor. The conductor can be a single solid-core wire or a bundle of stranded wires of smaller gauge. The conductor can be made of any suitable conducting material such as, but not limited to, brass, copper, steel or aluminium.

In another embodiment, the conductor can further comprise an insulating sheath. The insulating sheath can be disposed between said conductor and said tubular sheath in said passageway. In one embodiment, the insulating sheath can be made of suitable dielectric material including, but not limited to, polypropylene. In a representative embodiment, the conductor can be a 10-gauge insulated wire that fits within the passageway of the tubular sheath.

In one embodiment, the first connector can comprise a socket. The second connector can comprise a plug that releasably connects with the socket to form an electrical connection between adjoining wire-line sections. Similar to the conductor, the socket and the plug can be made of any suitable conducting material such as, but not limited to, brass, copper, steel or aluminium. In another embodiment, the first connector can be a hollow brass stub connected to the conductor at one end and the second connector can be a banana plug connected to the other end of the conductor. The banana plug is configured to fit snugly in the hollow receptacle of the brass stub. In a representative embodiment, the conductor can be soldered to the brass stub and to the plug in a wire-line section. The brass stub can be partially inserted into the first end of the sheath whereby a portion of the stub can extend from the first end of the sheath. In one embodiment, the stub and the first end of the sheath can comprise complementary threads such that the stub is threaded into the first end of the sheath. It should be obvious to one skilled in the art that the stub can be attached to the sheath in any number of ways that include but are not limited to mechanical fasteners, friction fitting the stub into the sheath and use of adhesives to hold the stub in place.

In yet another embodiment, the first connector can comprise a first conductive insert connected to the conductor at the first end of the sheath, and the second connector can comprise a second conductive insert connected to the other end of the conductor at the second end of the sheath. In further embodiments, the first and second inserts can be sealably affixed to the sheath with a suitable adhesive. In yet further embodiments, the first and second inserts can comprise complementary threads whereby the second insert of one wire-line section can be threaded into the first insert of a second wire-line section.

In one embodiment, the length of the conductor can be selected such that the end of the plug is approximately flush with the end of the second end of the sheath where it houses and protects said plug. The length of the conductor can easily be selected by a person skilled in the art to allow for the expansion and contraction of the conductor and the sheath and maintain an electrical connection between a pair of first and second connectors having regard to the down-hole environmental conditions including but not limited to pressure and temperature.

In another embodiment, the first connector can further comprise sealing means for providing a fluid-tight connection between releasably coupled first and second wire-line sections. In one embodiment, the sealing means can comprise an o-ring seal. In a representative embodiment, the first end of said tubular sheath can comprise a groove disposed about said first connector for receiving an o-ring. When a pair of wire-line sections is coupled together, the o-ring can be compressed thereby sealing the junction between the sheaths of the adjoining sections.

As noted above, the first and second connectors are coupled together with coupling means. The coupling means can be any suitable mechanical coupling means known in the art including, but not limited to, frictional means and threadably engaging means.

In one embodiment, the coupling means can include threads disposed about the exterior of the first connector and complementary threads disposed within said passageway at the second end of the sheath whereby a pair of wire-line sections can be coupled together by threading said first connector of a first wire-line section into the second end of a second wire-line section to couple said wire-line sections together. In so doing, the plug of one wire-line section can be inserted into the socket of the adjoining wire-line section.

In another embodiment, the coupling means can include a bayonet connector disposed on the first connector and bayonet receiver means disposed within the passageway of a second end of another wire-line section for receiving said bayonet connector whereby said wire-line sections can be coupled together by inserting the bayonet connector into the bayonet receiver means of the second wire-line section and turning or twisting the bayonet connector to releasably lock the wire-line sections together. In so doing, the plug of one wire-line section can be inserted into the socket of the adjoining wire-line section.

In another embodiment, the coupling means can include a quick connect plug disposed on a first connector and a quick connect coupler disposed on the second end of a second wire-line section similar to quick-release or locking ball connectors as used on air compressor connections and air hoses for use with pneumatic tools, as well known to those skilled in the art. In this manner, wire-line sections can be coupled together by inserting the quick connect plug of one wire-line section into the quick connect coupler of another wire-line section to lock the two together. In so doing, the plug of one wire-line section can be inserted into the socket of the adjoining wire-line section.

In another embodiment, the wire-line connection system can include a device connector that can be incorporated in a down-hole tool to permit connection to the wire-line in order to provide electric power to the tool. In a representative embodiment, the device connector can comprise a second connector having a plug to connect to a socket on a first connector of a wire-line section. In a further embodiment, the wire-line connection system can include an entry sub-assembly that passes through a pipe to connect with a wire-line section disposed within the pipe to provide electric power to the wire-line connection system.

In a representative embodiment, the wire-line system can include a plurality of wire-line sections connected to each other in series wherein one end of the connected wire-line sections can be coupled to a device connector mounted on a down-hole tool and wherein the other end of the connected wire-line sections can be coupled to an entry sub-assembly, which is in turn connected to a cable leading through an opening in the pipe to connect to a source of electric power to power the down-hole tool.

### BRIEF DESCRIPTION OF THE DRAWINGS

FIG. 1 is a side cross-sectional view depicting a wire-line section.

FIG. 2 is a side cross-sectional view depicting the wire-line section of FIG. 1 connected to a second wire-line section.

FIG. 3 is a side cross-sectional view depicting the wire-line section of FIG. 1 configured in a connection system to provide power to a down-hole tool.

FIG. 4 is a side cross-sectional view depicting an alternate embodiment of a wire-line section having bayonet connectors.

FIG. 5 is a side cross-sectional view depicting an alternate embodiment of a wire-line section having complementary connectors on opposing ends.

### DETAILED DESCRIPTION OF EMBODIMENTS

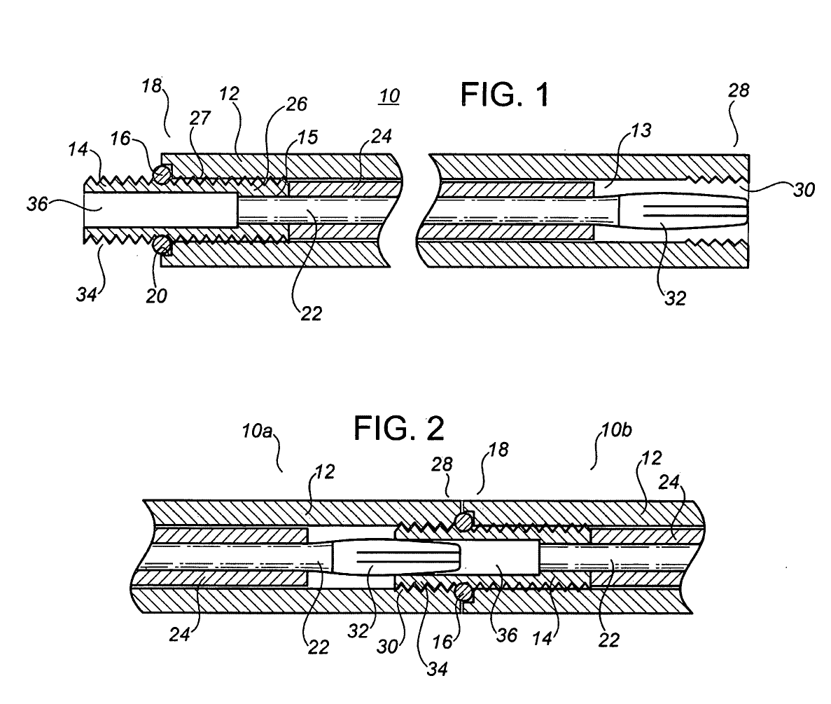

Referring to FIG. 1, an embodiment of wire-line section 10 is shown. Wire-line section 10 includes sheath 12 that has a first or socket end 18 and a second or plug end 28 with passageway 13 extending therebetween. In a representative embodiment, sheath 12 can be made of polyvinylchloride pipe having an inside diameter of ¼-inch. In typical applications, the length of wire-line section 10 can be selected to extend up to the entire length of a section of well pipe or it can be of shorter lengths.

Disposed within passageway 13 is conductor 22. Conductor 22 can be made of any suitable conducting material. In a representative embodiment, conductor 22 can be made of copper or aluminum and can further be a solid-core wire or be made of multiple strands of smaller gauge wire. In another embodiment, conductor can further include insulating sheath 24. In a representative embodiment, conductor 22 can be a length of 10-gauge insulated wire.

At socket end 18, socket 14 can be inserted into passageway 13 of sheath 12. In one embodiment, socket 14 can comprise threads 26 that thread into complementary threads 27 within passageway 13. Conductor 22 can be inserted into opening 15 of socket 14 and attached to socket 14. Socket 14 can be made of any suitable electrically conducting material such as, but not limited to, copper, aluminum, brass or steel. In one embodiment, socket 14 can be crimped to conductor 22. In another embodiment, socket 14 can be soldered to conductor 22. In the illustrated embodiment, socket 14 can further comprise threads 34 on the end of socket 14 that extend from sheath 12. Socket 14 can further comprise hollow receptacle 36 to receive a plug connector. In a representative embodiment, socket end 18 of sheath 12 can further comprise groove 20 to hold o-ring seal 16.

At plug end 28 of sheath 12, conductor 22 can comprise a plug connector. In the illustrated embodiment, the plug connector can be banana plug 32. Plug 32 can be made of any suitable electrically conducting material such as, but not limited to, copper, aluminum, brass or steel. Plug 32 can be attached to conductor 22, either by crimping or soldering the two together. Plug end 28 of sheath 12 can further comprise threads 30 which are complementary to threads 34 on socket 14. In a representative embodiment, the length of conductor 22 can be selected such that the end of plug 32 is approximately flush with plug end 28 of sheath 12.

Referring to FIG. 2, wire-line section 10a is shown connected to wire-line section 10b. Socket 14 of section 10b can be threaded into plug end 28 of section 10a. In the representative embodiment shown in FIG. 2, the sections can be threaded together until socket end 18 of section 10b abuts plug end 28 of section 10a. In this fashion, o-ring seal 16 is compressed to seal the junction between the two sections and acts to prevent any substances from the well pipe entering the wire-line sections. As sections 10a and 10b are connected together, banana plug 32 can be inserted into receptacle 36 of socket 14 to provide an electrical connection between the two sections.

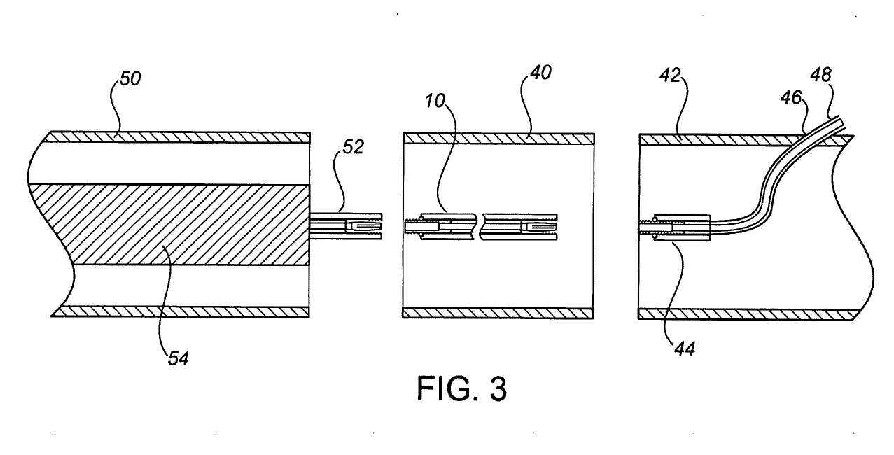

Referring to FIG. 3, an example wire-line connection system is shown. One wire-line section 10 is shown disposed in pipe section 40 for illustrative purposes only. It should be obvious to a person skilled in the art that a plurality of pipe sections 10 can be connected together with an equal number of wire-line sections 10 disposed therein to form a continuous wire-line connection system. Shown in pipe section 50 is down-hole tool 54 comprising device connector 52. Device connector 52 can be similar to plug end 28 of wire-line section 10 in that device connector 52 can comprise plug 32 and threads 30 within passageway 13 of sheath 12. Device connector 52 can be connected to socket end 18 of a wire-line section 10 that, in turn, can be connected to a plurality of wire-line sections 10 in series. In one embodiment, device connector 52 can be a stand-alone connector that can be operatively attached to down-hole tool 54. In another embodiment, device connector 52 can be integral to down-hole tool 54.

In pipe section 42 is entry sub-assembly 44 that can connect to the plug end 28 of the uppermost wire-line section 10. Entry sub 44 can comprise socket end 18 of a wire-line section 10 and can connect to plug end 28 of the uppermost wire-line section 10. Entry sub 44 can further comprise cable 48 that can pass through opening 46 in pipe section 42. Cable 48 can be connected to a source of electrical power that passes through entry sub 44 and all subsequent wire-line sections 10 to device connector 52 on down-hole tool 54.

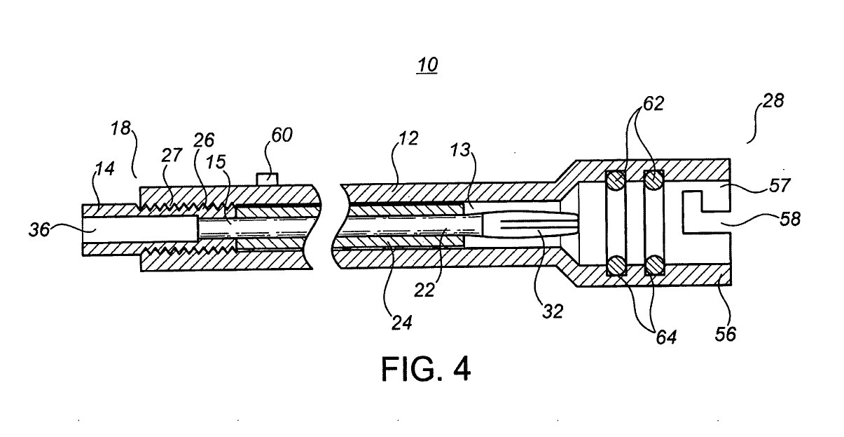

Referring to FIG. 4, an alternate embodiment of wire-line section 10 is shown. In this embodiment, plug end 28 can comprise flared end 56 having opening 57 and J-slot 58. Flared end 56 can further comprise at least one groove 64 for holding o-ring 62. In a representative embodiment, flared end 56 can comprise two grooves 64 within opening 57 for holding two o-rings 62. The diameter of opening 57 can be sized to permit socket end 18 of another wire-line section 10 to be inserted into flared end 56 such that contact can be made between o-rings 62 and socket end 18 of the second wire-line section 10 to form a liquid-tight seal between the wire-line sections. Socket end 18 of wire-line section 10 can further comprise locking pin 60 situated on the outer surface of sheath 12. When socket end 18 of wire-line section 10 is inserted into flared end 56 of another wire-line section 10, locking pin 60 can slide into J-slot 58 as far as it can go whereupon one wire-line section 10 is twisted with respect to the other so that locking pin 60 can be secured in J-slot 58 as well known to those skilled in the art. In connecting wire-line sections together in this manner, wire-line sections can be assembled together quickly and securely.

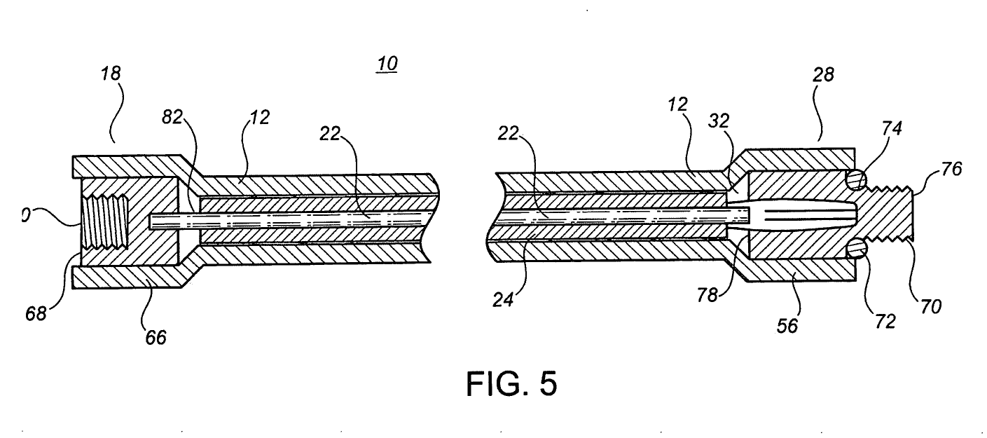

Referring to FIG. 5, another embodiment of wire-line section 10 is shown. In this embodiment, socket end 18 can comprise flared end 66 to accommodate receiving conductive socket insert 68. Socket insert 68 can be made of any suitable electrically conducting material such as, but not limited to, copper, aluminum, brass or steel. In further embodiments, socket insert 68 can be sealably affixed to flared end 66 with a suitable adhesive to seal sheath 12 at socket end 18. Conductor 22 can be connected to socket insert 68 and inserting a portion of conductor 22 into opening 82 and soldering the two together. Alternatively, socket insert 68 can be crimpled onto conductor 22. At plug end 28, conductive plug insert 70 can be inserted into flared end 56. Plug insert 70 can be made of any suitable electrically conducting material such as, but not limited to, copper, aluminum, brass or steel. As described in the embodiments above, banana plug 32 can be soldered or crimped onto conductor 22. When plug insert 70 is inserted into flared end 56, banana plug 32 can slide into opening 78 to make the electrical connection with plug insert 70. In one embodiment, plug insert 70 can be affixed to flared end 56 with a suitable adhesive to seal off sheath 12 at plug end 28.

In other embodiments, plug insert 70 can comprise groove 74 around the base of threaded portion 76 to hold o-ring 72. O-ring 72 provides the sealing means between adjoining wire-line sections. To join two wire-line sections together, the threaded portion 76 of one section is threaded into the threaded opening 80 of socket insert 68 of a second section. It should be noted that the use of banana plug 32 and opening 78 on plug insert 70 is one of convenience in the manufacture of wire-line section 10 and not one of necessity. It should be obvious to those skilled in the art that conductor 22 can be electrically connected to plug insert 70 by extending opening 78 all the way through plug insert 70 to the end of threaded portion 76 where conductor 22 can extend through and be soldered or crimped to threaded portion 76. It is also contemplated that a pin could be struck through threaded portion 76 and conductor 22 to make the electrical connection as well.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

We claim:

1. A wire-line section, comprising:
a) a tubular sheath having first and second ends and forming a passageway therebetween;
b) a conductor disposed within said passageway extending between the first and second ends;
c) a first connector operatively attached to the conductor at the first end, the first connector operatively attached to the first end of the tubular sheath;
d) a second connector operatively attached to the conductor at the second end, the first and second connectors configured to releasably connect with one another; and
e) coupling means for releasably coupling the first connector with the second end of a second wire-line section whereupon releasably coupling the wire-line section to the second wire-line section, the first connector is releasably connected with the second connector of the second wire-line section.

2. The wire-line section as set forth in claim 1 wherein the conductor further comprises an insulating sheath covering at least a portion of the conductor, the insulating sheath disposed between the conductor and the tubular sheath in the passageway.

3. The wire-line section as set forth in claim 2 wherein the insulating sheath comprises a dielectric insulator.

4. The wire-line section as set forth in claim 1 wherein the first connector further comprises sealing means for sealing the connection between the wire-line section and the second wire-line section when the wire-line sections are releasably coupled together.

5. The wire-line section as set forth in claim 4 wherein the sealing means comprises an o-ring seal.

6. The wire-line section as set forth in claim 5 wherein the first end of the tubular sheath further comprises a groove disposed about the first connector for receiving the o-ring seal.

7. The wire-line section as set forth in claim 1 wherein the first connector is threadably coupled to the tubular sheath at the first end.

8. The wire-line section as set forth in claim 7 wherein the first connector further comprises a socket for releasably connecting with the second connector of the second wire-line section.

9. The wire-line section as set forth in claim 8 wherein the second connector comprises a plug for releasably connecting with the socket.

10. The wire-line section as set forth in claim 1 wherein the coupling means comprises:
a) first threads disposed about the first connector; and
b) second threads disposed within the passageway at the second end of the wire-line section whereby the wire-line sections are coupled together by threading the first connector into the second end of the second wire-line section.

11. The wire-line section as set forth in claim 10 wherein the first connector further comprises a socket for releasably connecting with the second connector of the second wire-line section.

12. The wire-line section as set forth in claim 11 wherein the second connector comprises a plug for releasably connecting with the socket.

13. The wire-line section as set forth in claim 1 wherein the coupling means comprises:
a) a bayonet connector disposed on the first connector; and
b) bayonet receiver means disposed within the passageway at the second end of the wire-line section for receiving the bayonet connector whereby the wire-line sections are coupled together by inserting the bayonet connector into the bayonet receiver means of the second wire-line section.

14. The wire-line section as set forth in claim 13 wherein the first connector further comprises a socket for releasably connecting with the second connector of the second wire-line section.

15. The wire-line section as set forth in claim 14 wherein the second connector comprises a plug for releasably connecting with the socket.

16. The wire-line section as set forth in claim 1 wherein the coupling means comprises:
a) a quick connect plug disposed on the first connector; and
b) a quick connect coupler disposed on the second end of the second wire-line section whereby the wire-line sections are coupled together by inserting the quick connect plug into the quick connect coupler.

17. The wire-line section as set forth in claim 16 wherein the first connector further comprises a socket for releasably connecting with the second connector of the second wire-line section.

18. The wire-line section as set forth in claim 17 wherein the second connector comprises a plug for releasably connecting with the socket.

19. The wire-line section as set forth in any of claims 1 to 4 wherein the first connector further comprises a first conductive insert having a socket, the first insert disposed in the first end of the sheath, the first insert operatively connected to the conductor.

20. The wire-line section as set forth in claim 19 wherein the second connector further comprises a second conductive insert having a plug, the second insert disposed in the second end of the sheath, the second insert operatively connected to the conductor.

21. The wire-line section as set forth in claim 20 wherein the coupling means further comprises:
a) threads disposed in the socket; and
b) threads disposed on the plug whereby the plug can threadably couple and uncouple with the socket on an adjoining wire-line section.

22. A wire-line connection system, comprising:
a) a wire-line entry sub-assembly;
b) a plurality of wire-line sections, each section comprising:
i) a tubular sheath having first and second ends and forming a passageway therebetween,
ii) a conductor disposed within the passageway extending between the first and second ends,
iii) a first connector operatively attached to the conductor at the first end, the first connector operatively attached to the first end of the tubular sheath,
iv) a second connector operatively attached to the conductor at the second end, the first and second connectors configured to releasably connect with one another, and
v) coupling means for releasably coupling the first connector with the second end of a second wire-line section whereupon releasably coupling the wire-line section to the second wire-line section, the first connector is releasably connected with the second connector of the second wire-line section; and
c) a device connector for attachment to a down-hole tool whereby the entry sub-assembly, the plurality of wire-line sections and the device connector are connected in series to carry electrical power to the down-hole tool from a source of electrical power connected to the entry sub-assembly.

23. The wire-line connection system as set forth in claim 22 wherein the conductor further comprises an insulating sheath covering at least a portion of the conductor, the insulating sheath disposed between the conductor and the tubular sheath in the passageway.

24. The wire-line connection system as set forth in claim 23 wherein the insulating sheath comprises a dielectric insulator.

25. The wire-line connection system as set forth in claim 22 wherein the first connector further comprises sealing means for sealing the connection between the wire-line section and the second wire-line section when the wire-line sections are releasably coupled together.

26. The wire-line connection system as set forth in claim 25 wherein the sealing means comprises an o-ring seal.

27. The wire-line connection system as set forth in claim 26 wherein the first end of the tubular sheath further comprises a groove disposed about the first connector for receiving the o-ring seal.

28. The wire-line connection system as set forth in claim 22 wherein the first connector is threadably coupled to the tubular sheath at the first end.

29. The wire-line connection system as set forth in claim 28 wherein the first connector further comprises a socket for releasably connecting with the second connector of the second wire-line section.

30. The wire-line connection system as set forth in claim 29 wherein the second connector comprises a plug for releasably connecting with the socket.

31. The wire-line connection system as set forth in claim 22 wherein the coupling means comprises:
a) first threads disposed about the first connector; and
b) second threads disposed within the passageway at the second end of the wire-line section whereby the wire-line sections are coupled together by threading the first connector into the second end of the second wire-line section.

32. The wire-line connection system as set forth in claim 31 wherein the first connector further comprises a socket for releasably connecting with the second connector of the second wire-line section.

33. The wire-line connection system as set forth in claim 32 wherein the second connector comprises a plug for releasably connecting with the socket.

34. The wire-line connection system as set forth in claim 22 wherein the coupling means comprises:
a) a bayonet connector disposed on the first connector; and
b) bayonet receiver means disposed within the passageway at the second end of the wire-line section for receiving the bayonet connector whereby the wire-line sections are coupled together by inserting the bayonet connector into the bayonet receiver means of the second wire-line section.

35. The wire-line connection system as set forth in claim 34 wherein the first connector further comprises a socket for releasably connecting with the second connector of the second wire-line section.

36. The wire-line connection system as set forth in claim 35 wherein the second connector comprises a plug for releasably connecting with the socket.

37. The wire-line connection system as set forth in claim 22 wherein the coupling means comprises:
a) a quick connect plug disposed on the first connector; and
b) a quick connect coupler disposed on the second end of the second wire-line section whereby the wire-line sections are coupled together by inserting the quick connect plug into the quick connect coupler.

38. The wire-line connection system as set forth in claim 37 wherein the first connector further comprises a socket for releasably connecting with the second connector of the second wire-line section.

39. The wire-line connection system as set forth in claim 38 wherein the second connector comprises a plug for releasably connecting with the socket.

40. The wire-line connection system as set forth in claim 22 wherein the device connector is operatively attached to the down-hole tool.

41. The wire-line connection system as set forth in claim 22 wherein the device connector is integral to the down-hole tool.
